(19) United States
(12) Patent Application Publication
(10) Pub. No.: US 2026/0205296 A1
(43) Pub. Date: Jul. 16, 2026

(54) Technique for Controlling a Signature Creation

(71) Applicant: Bayerische Motoren Werke Aktiengesellschaft, Muenchen (DE)

(72) Inventors: Matthias Fink, Muenchen (DE); Marco Hippler, Muenchen (DE)

(21) Appl. No.: 19/447,027

(22) Filed: Jan. 13, 2026

(30) Foreign Application Priority Data
Jan. 15, 2025 (DE) 10 2025 101 353.5

(51) Int. Cl. H04L 9/32

(52) U.S. Cl. CPC H04L 9/3213; H04L 9/3247

(57) ABSTRACT

A method for controlling a signature creation, e.g. in a terminal device, may comprise receiving signature data; sending a signature request to sign the received signature data by means of a hardware token; receiving a signature response to the signature request from the hardware token, wherein the signature response contains a signature; and forwarding the signature to a backend for verification of the signature.

### CROSS REFERENCE TO RELATED APPLICATION

This application claims priority under 35 U.S.C. § 119 from German Patent Application No. DE 10 2025 101 353.5, filed Jan. 15, 2025, the entire disclosure of which is herein expressly incorporated by reference.

### BACKGROUND AND SUMMARY

The invention relates to methods for controlling a signature creation and for verifying the created signature. The invention can be implemented on a terminal device, a hardware token such as a smart card, and in a backend.

It is known that a digital key (e.g. for a vehicle) can be stored on a terminal device, e.g. a smartphone, for example in a secure memory of the device. Use of the key is based on interfaces between the secure memory and a device operating system, as well as on interfaces between the operating system and other applications running on the device.

With the Digital Key Release 3, the Car Connectivity Consortium (CCC) defines a standard for a digital vehicle key in the form of a technical specification. Corresponding digital keys are being increasingly widely used in an expanded vehicle environment.

An application or app of a vehicle manufacturer can be installed on a terminal device, which allows access to the vehicle by means of the digital vehicle key stored on the device, allows control of certain vehicle functions, etc. Extended usage possibilities also result from the existence of a backend system for managing the digital vehicle key.

A digital key or vehicle key can be created, for example, by coupling a terminal device with a vehicle. In a CCC context, this is called owner-pairing. A prerequisite is that a proof of ownership is provided in relation to the vehicle, e.g. by presenting two key rings or key fobs in parallel. A digital key can also be passed from one device to another (“key sharing”), e.g. from one user to another user (for example, in a private use case), or from a backend to a user (for example, in a commercial server-to-user use case).

Smart cards with CCC-compatible digital keys already exist, but these smart cards are proprietary. For example, there is currently no means whereby an individual user can share their CCC-compliant digital key to a smart card. However, several variants of smart cards with digital keys are currently defined or standardized by the CCC. In one variant, a vehicle manufacturer can provide a smart card with a vehicle key (second key) permanently stored on it. In another variant, a smart card can be made available to a vehicle keeper or owner, on which any key can be stored and deleted again.

Methods for digital signature creation are used to verify the authenticity of digital messages, documents, data, etc. For example, a valid digital signature for a message gives a recipient the assurance that the message came from a sender known to the recipient. A digital signature can therefore be used to perform and secure a data transmission, electronic transactions, generally for administrative purposes, management such as activation of a service, etc.

A digital signature can be based on a cryptographic method, e.g. a digital signature can use asymmetric cryptography. A digital signature key is therefore understood to mean a (digital, electronic) cryptographic component which can be used in (digital, electronic) signature processes to verify, and thereby ensure or secure, the identity of a signatory and/or the integrity of a document, data set, etc.

In general, other digital keys, in addition to signature keys that are specifically provided for this purpose, can be used to create a signature. For example, a digital vehicle key mentioned above can also be used to sign arbitrary data (a concept for signing “arbitrary data” is defined by the CCC). CCC Release 4 will also make it possible to delegate vehicle-related rights for sharing a digital vehicle key (“key sharing”) to a backend, and in this context it is also conceivable that the digital vehicle key will be used for signing.

For the creation of arbitrary signatures, terminal devices such as smartphones, smartwatches, etc. use a two-layered approach: a device framework layer accepts the arbitrary data (e.g. from an app provided by a vehicle manufacturer), creates a hash over this and further information such as an app ID (bundle ID, package name), and passes the hash to a secure element of the device which holds the digital key for signature creation.

An APDU-SIGN command (APDU=“Application Protocol Data Unit”) is specified by the CCC for terminal devices such as smartphones or smartwatches. However, (re-) using this APDU-SIGN command for smart cards leads to security vulnerabilities: in principle, a smart card can be used to imitate a signature as if it had been generated by an internally held key (e.g. any desired app ID can be specified). A positive verification can be given incorrectly if this is not very accurately or correctly implemented. The positive verification can also be incorrectly given if the input data (tag 0x58, cf. a TLV standard known per se) is returned to the backend, namely if (in the case of inaccurate implementation) the returned hash is used for verification, instead of creating it independently on the basis of the input data.

An object of the present invention is to provide an improved approach to a technique for controlling signature creation. The invention achieves this object by means of the subject matter of the independent claims. Dependent claims reproduce preferred embodiments.

A first aspect of the present invention relates to a method for controlling a signature creation. The method can be implemented in a terminal device or in a motor vehicle. For example, the method can be implemented by an operating system, a framework for digital keys (“DK Framework”), etc. The method comprises receiving signature data; sending a signature request for signing the received signature data by means of the hardware token; receiving a signature response to the signature request, wherein the signature response contains a signature; and forwarding the signature (e.g. to a backend) for verification of the signature.

The signature data can comprise, for example, arbitrary data as defined by CCC. The signature data can originate, for example, from an app that interacts with the hardware token for signature creation. The (verified) signature can implement, for example, a second factor (two-factor authentication, 2FA, or multi-factor authentication, MFA), confirmation of a challenge of input data, etc.

In some embodiments of this aspect of the invention, the signature requirement contains a parameter (e.g. “P1” parameter according to CCC), which is set to a value that indicates that user authentication is not required. In other embodiments, the parameter can be set to a value that indicates that user authentication is required.

A second aspect of the present invention relates to a method for signature creation in a hardware token. The method comprises receiving a signature request to sign signature data from a terminal device; creating a signature with a digital signature key; and sending a signature response containing the signature to the terminal device. The digital signature key is stored in the hardware token. The signature is created on data that includes the signature data and a predefined additional data item.

For example, the hardware token may be a smart card, memory card, chip card, etc., or any other physical carrier, which instead of a card format may also have, for example, a form factor like a USB token, or a key fob. In general, the physical carrier may have a carrier structure such as a card, a stick, etc., wherein the structure carries, contains, incorporates etc. a data memory, chip, etc. For example, if the carrier is embodied as a memory card, it can be, for example, a plastic card, chip card, smart card, etc. with an integrated circuit (chip) or any other hardware logic and/or a memory, a microprocessor, etc. The reference to a hardware token herein shall also include a token only available in the future, provided that this has the necessary processor capacities, memory capacities, etc. for implementing an aspect of the invention described herein.

The specified or predefined, e.g. standardized additional data item may comprise a variable value or may comprise a fixed value. In some embodiments of this aspect of the invention, the predefined further data item may comprise a string. In some embodiments illustrative of this, the string can be, for example, “HW Token”, “HARDWARE-TOKEN”, “HARDWARETOKEN”, etc. In other embodiments, a completely different string (e.g. ASCII sequence, or its (hash) value) can be used. The string can generally be chosen arbitrarily, but can indicate the type of signature creation, which facilitates the implementation of the corresponding signature procedure (and the verification procedure). The string can be standardized.

For example, creating the signature can include calculating a hash value. Such a hash or hash value can generally relate to a known hash function, in particular a cryptographic hash function such as an SHA-2 function, i.e. SHA-224, SHA-256, SHA-384, SHA-512, etc.

In some embodiments of this aspect of the invention, the signature response does not contain the signature data. In a CCC context or environment, this means that a tag 0x58 or 58 h is not returned, whereas this is the case for an already known “OEM App Data Attestation” (cf. CCC, Chapter 14.4 and the reference there to Table 15-65).

A third aspect of the present invention also relates to a method for signature creation in a hardware token. The method comprises receiving a signature request to sign signature data from a terminal device; creating a signature with a digital signature key, wherein the digital signature key is stored in the hardware token; and sending a signature response containing the signature to the terminal device, wherein the signature response does not contain the signature data.

In some embodiments of this aspect of the invention, the signature is created on data comprising the signature data and a predefined further data item. Embodiments of the predefined further data item include, mutatis mutandis, the embodiments outlined above with respect to the second aspect of the invention.

In some embodiments of the second or third aspect of the invention, the method does not provide for user authentication. In some of these embodiments, the hardware token does not handle or intercept a case in which user authentication is provided according to a passed parameter value. In a CCC environment, such a parameter value, when received in a signature request, can be interpreted as “Reserved for Future Use” (RFU).

In some embodiments of the invention, the signature request is implemented as an APDU command and/or the signature response as an APDU response.

A fourth aspect of the present invention relates to a method for verifying a signature in a backend. The method comprises receiving a request containing a signature from a terminal device; providing signature data; verifying the signature based on data comprising the signature data and a predefined further data item; and sending a response to the request, wherein the response relates to a result of the verification.

Embodiments of this aspect of the invention can trace a proper signature creation in the hardware token at the backend and compare the result with the received signature. In preferred embodiments, in particular, the signature data is provided independently of whether any data is contained with the request. If, for example, the signature data used by the hardware token is contained in the request, this data is preferably not used for verification in the backend.

A further aspect of the present invention relates to a terminal device or a motor vehicle which is designed for carrying out a corresponding method described herein for controlling a signature creation.

A still further aspect of the present invention relates to a hardware token. A digital signature key is stored on the hardware token. The hardware token is designed to carry out a corresponding method described herein for signature creation.

A further aspect of the present invention again relates to a backend server which is designed for carrying out a corresponding method described herein for verifying a signature.

One aspect of the present invention relates to a system for creating and verifying a signature in a vehicle environment. The system comprises the motor vehicle and a hardware token described herein, which can be delivered, for example, together with the vehicle, is available to and/or provided to a vehicle owner, etc. In one embodiment, a digital vehicle key for the motor vehicle is stored on the hardware token, for example as a second key. This vehicle key can be used as a signature key and/or a separate digital signature key is also stored on the HW token.

The system may also comprise an application for a signature creation described herein, which may be provided by a manufacturer of the motor vehicle (or a service provider). The application can relate, for example, to management of digital vehicle keys for the motor vehicle. The application may be provided for installation or implementation on a terminal device of a vehicle owner or vehicle user.

The system may further comprise a backend server, which is designed for verification of a signature as described herein. For example, the server can be operated by a manufacturer of the motor vehicle, a service provider, etc.

Forms of the invention are now described in more detail with reference to the accompanying drawings, in which other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first exemplary embodiment of a system according to the invention;

FIG. 2 shows a second exemplary embodiment of a system according to the invention;

FIG. 3A shows a detailed flowchart of a first method in the system of FIG. 2;

FIG. 3B shows a detailed flowchart of a second method in the system of FIG. 2; and

FIG. 3C shows a detailed flowchart of a third method in the system of FIG. 2.

### DETAILED DESCRIPTION OF THE DRAWINGS

A terminal device is understood herein to mean any device which implements an end point for electronic communication, a communication network, etc. and which is designed for use, operation, etc. by a human user, a person, an operator, a service employee, etc., for example using an HMI (Human Machine Interface). For example, a terminal device can be a mobile device, a portable device, a wearable, etc., i.e. a notebook, tablet or smartphone, a smartwatch, a smartband, a SmartRing, etc. Devices for stationary use, such as a PC, an operating console, etc., are also regarded as terminal devices.

The reference to a terminal device herein shall also include a terminal device only available in the future, provided that this has the necessary processor capacities, memory capacities, etc. for implementing an aspect of the invention described herein.

A terminal device can have a secure memory or secured environment, a secured element etc., e.g. based on a corresponding chip, a crypto-processor, etc. For example, the secure memory can be an HSM (“Hardware Security Module”), TPM (“Trusted Platform Module”), a secured element (“Secure Element”, “Secure Enclave”), a TEE (“Trusted Execution Environment”), etc. The secure memory can hold a digital vehicle key and/or signature key, for example.

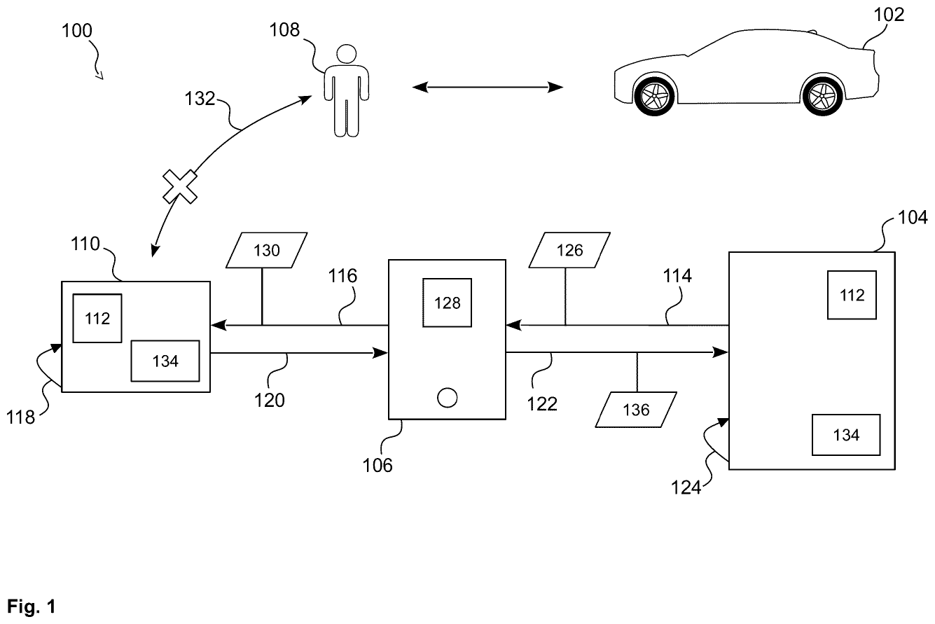

FIG. 1 shows in schematic form an exemplary embodiment of a system 100 having a motor vehicle 102, a server 104 of a backend system for the vehicle 102, a terminal device 106 of a user 108, and a hardware token 110.

The user 108 may be an owner of the vehicle 102 or another user authorized to drive the vehicle 102. The hardware token 110 can be provided to the user 108, for example by a manufacturer or keeper of the vehicle. For example, the hardware token 110 can be a smart card, or be designed as a chip card in a bank card format, etc. The hardware token 110 stores a signature key 112, which can be a vehicle key for accessing the vehicle 102, or a separate key.

The digital key 112 stored in the hardware token 110 is intended to be used to create a signature for “arbitrary data” (e.g. according to CCC). Depending on the use case, the signature can be created, for example, as part of a confirmation of input data, in which case, for example, an app on the terminal device 106 can interact with the hardware token 110 to create a signature over the input data. Another use case can be a confirmation of a challenge received by the backend 104, e.g. one-time information (“nonce”), etc. Yet another use case may involve a second factor in a 2FA or MFA.

Another use case can relate to vehicle access in an emergency, in which a central ECU has failed and direct communication takes place between an ECU (“electronic control unit”) for vehicle access and the hardware token 110. Further use cases, including future ones, are conceivable.

The terminal device 106 (more precisely, an operating system, a framework layer, etc. of the terminal device 106) has at least two instructions or commands for signature creation available. Accordingly, a signature can be created either with a key that is held internally in the terminal device 106, or a signature can be created with the signature key 112 which is held externally, i.e. by the hardware token 110.

According to the exemplary embodiment described here, a signature creation is intended to be carried out with the key 112, for example because the device does not have an appropriate internal signature key for the particular use case. For this reason, terminal device 106 selects the corresponding stand-alone command, e.g. an APDU command with the call “HARDWARE TOKEN SIGN”. According to the invention this command is specifically adapted to signature creation with a hardware token, as described below, and with regard to optimal robustness of a signature and verification procedure.

For illustration purposes, it is abstractly assumed that “arbitrary data” is sent from the backend 104 to the terminal device 106 in a process 114 in a CCC environment. This data is passed to the hardware token 110 in a process 116 (this corresponds to calling a HARDWARE TOKEN SIGN command as described above), and signed there in a process 118. A signature response, in the example a HARDWARE TOKEN SIGN response, is returned to the terminal device 106 in a process 120. For verification, the terminal device 106 sends signature-related data or attestation data to the backend 104 in a process 122, where this data is processed in a verification process 124.

Specifically, in the process 114 arbitrary data 126 is sent to the terminal device 106, e.g. to an app (not indicated in FIG. 1). In the terminal device 106, the arbitrary data 126 can be transferred from the app to a framework for handling or managing digital keys for the purpose of signature creation. The framework can prepare attestation data, i.e. additional data (such as a bundle ID) is added to the arbitrary data and a hash is created over this data.

The terminal device 106 has a signature module 128, which can be implemented as a part of the requesting app, in the framework layer and/or as a stand-alone unit. The signature module 128 sends a signature command or a signature request for signature creation.

In an exemplary embodiment in the CCC environment, at least two signing commands are available: a conventionally known APDU SIGN command as well as the APDU HARDWARE TOKEN SIGN command proposed here according to the invention and described below (there could also be further commands available for signature creation).

With reference to the conventional APDU SIGN command, the terminal device 106 may contain e.g. a secure memory (not shown in FIG. 1 for reasons of clarity) in which a signature key is held (i.e., a further signature key in addition to the signature key 112 in the hardware token 110).

In principle, the signature could be created using the key 112 stored on the hardware token 110 by means of the conventional SIGN command according to CCC. However, while a signature creation with a conventional SIGN command using a key stored in an integrated secure memory of the terminal can be considered sufficient to guarantee device integrity, such integrity is not provided if it is intended to create a signature using a key that is held on a hardware token. In order to nevertheless enable a trustworthy signature creation, it is proposed according to the invention to provide a stand-alone command for a signature creation with such a hardware token, in the present exemplary embodiment the APDU HARDWARE TOKEN SIGN command.

It is advantageous if the hardware token 118 only offers one command, e.g. the HARDWARE TOKEN SIGN command described here. If the hardware token 118 were alternatively or additionally to offer the conventional SIGN command according to CCC, it would be possible to mimic a device-internal signature. However, if the hardware token 118 only offers one command, the APDU command as sent by the signature module 128 could even be defined identically, i.e. a device such as the terminal device 106 can implement either the conventional variant of the SIGN command or the variant proposed here (HARDWARE TOKEN SIGN).

In one exemplary embodiment, the arbitrary data 126 relates to a use case in an extended environment of the vehicle 102, where the user 108 is not the owner of the vehicle 102 but has been provided with the hardware token 110 with a vehicle key stored thereon, for example for temporary use of the vehicle 102. In this case, the signature key 112 of the hardware token 110 must be used.

In the example described here, it is assumed that the signature module 128 sends the APDU HARDWARE TOKEN SIGN command for signature creation to the hardware token 118. The input data 130 compiled for an attestation, which is passed to the hardware token 110 for signature creation in the process 116, comprises the arbitrary data 126 and additional data.

A conventional SIGN command according to CCC can contain a parameter P1 in the payload, which specifies whether or not to initiate or perform a user authentication 132. If the parameter P1 is set to a value of 00h, user authentication must be performed. If the parameter P1 is set to a value of 01h, no user authentication is to be performed. The HARDWARE TOKEN SIGN command proposed according to the invention may contain a comparable parameter in the payload, which specifies whether or not the hardware token should initiate a user authentication 132. Preferably, the parameter has only one significant value, e.g. 01h, which is to be interpreted in such a way that a user authentication 132 must not be carried out, as indicated in FIG. 1.

In a simple exemplary embodiment in which the HARDWARE TOKEN SIGN command according to the invention is derived via modifications of the conventional SIGN command, the parameter P1 could be permanently set to the value 01h by the framework in the terminal device 106. For all other values, an interpretation as “RFU” could be standardized (RFU=“Reserved for Future Use”). This enables a particularly simple implementation according to the invention in a hardware token.

It should be noted here that current hardware tokens typically do not support user authentication. If future hardware tokens were to support user authentication, these can be considered in the manner known from a conventional SIGN command. However, until such tokens emerge, the robust and less error-prone implementation described here is suggested instead.

In one exemplary embodiment, the parameter P1 can also be set to a value that indicates that user authentication is required. For example, a digital key fob could have a display, via which a PIN (“Personal Identification Number”) could be entered to enable it.

In the process 116, the compiled signature data or attestation data are sent to the hardware token 110, in which a procedure 118 according to the invention for signature creation is then executed.

According to the invention, the arbitrary data 130 passed to the APDU SIGN command by the caller in the terminal device 106 is embedded in a data structure which comprises a further data item 134 permanently specified for this command, namely (in the exemplary embodiment described here) the string “HARDWARETOKEN” (see Table 15-5X “Hardware Token Data Attestation Input” described below for illustration). In the subsequent procedure 118, the hardware token 110 creates a hash over this data structure (i.e. not over the input data 130). The hash creation itself, as well as a signature creation on the hash using the key 112 can take place, e.g. as known from a conventional SIGN procedure according to CCC.

Because the signature in the hardware token 110 is not created on the arbitrary data 130, this signature can be clearly distinguished from a signature created in the terminal device and made on the arbitrary data 130. Conversely, this means that the hardware token 110 cannot be used to fake or mimic a signature created with a device-internal key. This increases the robustness of the signature creation in the environment described here.

With the signature response 120, the hardware token 110 returns a data structure to the terminal device 106 which does not contain the input data 130, i.e., does not contain a tag 0x58 or 58h (for illustration purposes see Table 15-61 described below: “HARDWARE TOKEN SIGN Response” and Table 15-60: “SIGN Data Fields”). In contrast, a conventional SIGN command according to CCC returns the arbitrary data (see, for example, Chapter 14.4 “OEM App Data Attestation” in a CCC specification and Table 15-65 referenced there).

The inventors have recognized that the return of the arbitrary data during signature creation or verification can lead to security vulnerabilities, as follows. Referring to the example scenario of FIG. 1, for the verification 124 of the signature 136, which in process 122 is forwarded from the terminal device 106 to the backend 104 in process 122, the backend 104 contains the signature key 112 (the details of this, in particular regarding asymmetric encryption, are known to the person skilled in the art), and the specified data item 134. A robustly implemented verification of the signature 136 requires, inter alia, that a hash value be created based on the arbitrary data on which the signature is also created; more precisely, the hash value should be created over the data 126 sent from the backend 104 to the terminal device 106. If a hash value returned in process 122 is instead compared with a hash value created from the signature 136 however, the verification process always returns a positive (but possibly incorrect) result.

In a procedure according to the invention however, the hash 130 cannot be inadvertently adopted, since it is not returned by the hardware token 110 in process 120 (and/or is not forwarded by the terminal device 106 or transmitted to the backend 104 in process 122). Therefore, a robust implementation of the verification by the backend 104 is required.

In the exemplary embodiment described here, however, the verification would fail even if the attestation data 130 were inadvertently used, because the signature 136 created in process 118 is not created on the data 130, as described above.

In the exemplary embodiment shown in FIG. 1, input data 126 is transmitted by the backend 104. Depending on the use case, the input data can also be provided in whole or in part by an app and/or a framework layer on the terminal device 106.

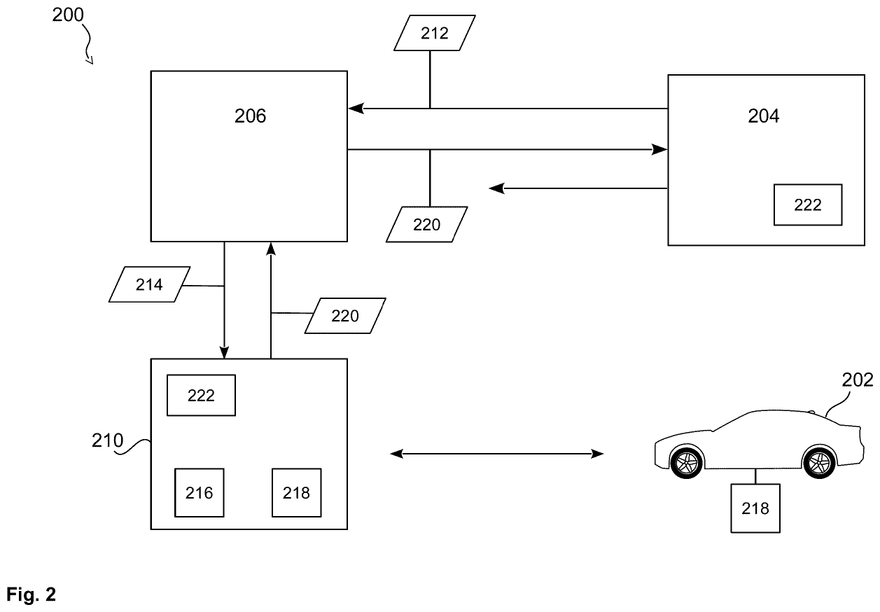

FIG. 2 shows a further exemplary embodiment of a system 200 according to the invention having a motor vehicle 202, a backend server 204, a terminal device 206 and a hardware token 210. The components of the system 200 interact for a procedure according to the invention for creating and verifying a signature. In this case, terminal device 206 and hardware token 210 are to be understood as separate components; use of the hardware token 210 is carried out as described below by positioning the hardware token 210 near to the terminal device 206.

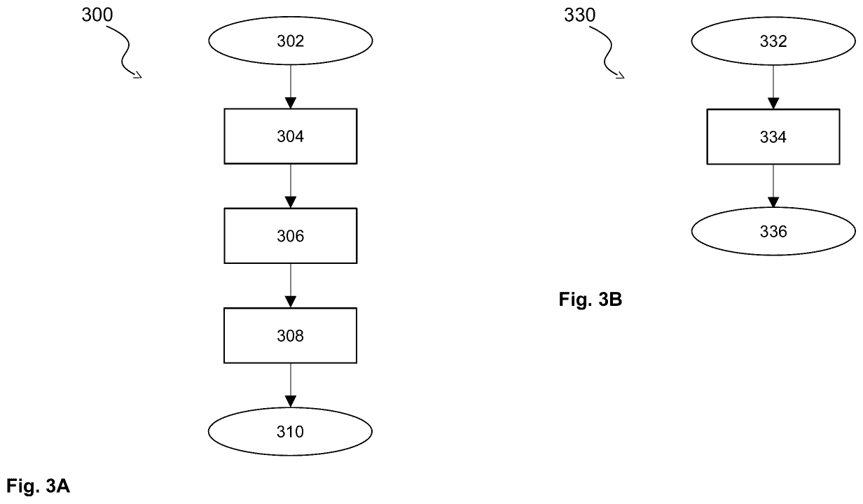

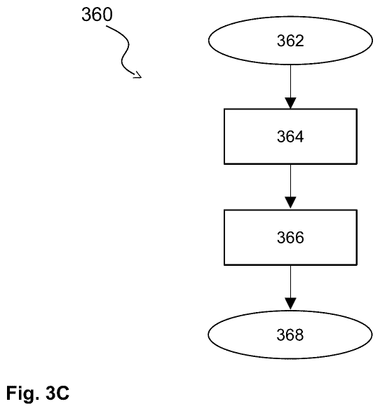

A concrete procedure for a signature creation in the system 200 is described in more detail below with reference to the sequences schematically illustrated in FIGS. 3A, 3B and 3C. In these, FIG. 3A shows a sequence of a method 300 for controlling a signature creation in the terminal device 206. FIG. 3B shows a sequence of a corresponding method 330 in the hardware token 210. FIG. 3C shows a sequence of a corresponding method 360 in the server 204.

In the following, some details of terms, definitions, properties, etc. used are not described again if they are already discussed elsewhere.

A sequence begins in a step 302 in method 300 in FIG. 3A with the signature data 212 being received (in the example by the backend server 204), for which a signature is to be created. The signature data 212 can be any (arbitrary, any kind of) data.

For the terminal device 204 (more precisely, an operating system, framework layer, etc. of the terminal device 204) at least two routines, processes or alternatives for signature creation are available, wherein at least one alternative relates to signature creation according to the invention. Decision criteria for selecting a specific signature request or a specific signature command are discussed herein at various points.

In a step 304, the terminal device 204 sends a signature request to sign the received signature data 212 by means of a hardware token. The signature request is sent to the hardware token 210 in the form of an instruction or command and can contain a parameter 214 which is set to a value indicating that user authentication is not required. For the parameter 212, only a single value (or multiple values, a range of values, multiple value ranges) which transports this indication may be provided, while all other values (or value ranges) do not carry an indication, i.e. are interpreted e.g. as RFU.

In a corresponding step 332 in method 330 in FIG. 3B, the signature request sent from the terminal device 206 is received by the hardware token 210. Since the parameter 212 specifies that no user authentication should occur, the procedure in the hardware token 210 does not contain any form of user authentication.

In a step 334, the hardware token 210 creates a signature with a digital signature key 216 held in the hardware token 210. The signature key 216 may be identical to a digital vehicle key 218 for access to the vehicle 202, wherein the vehicle key 218 is also stored on the hardware token, or signature key 216 and vehicle key 218 may be different, as indicated in FIG. 2 (signature key 216 and vehicle key 218 can be part of a common key hierarchy).

The signature 220 in step 334 is created on data which comprises the signature data 212 and a predefined further data item 222. The specified additional data item can be a fixed value. In an exemplary embodiment, this value can be a string, for example in an ASCII code, Unicode, etc., as is familiar to the person skilled in the art (ASCII=“American Standard Code for Information Interchange”). For example, the value can correspond to a string “HARDWARETOKEN”.

In a step 336, the hardware token 210 sends a signature response back to the terminal device 206. The response contains the signature 220. However, the signature response does not return the previously received signature data 212. In a CCC context, this means that the signature response does not contain a tag 0x58. The signature creation process in the hardware token 210 is then completed.

In a corresponding step 306 (method 300 in FIG. 3A), the terminal device 206 receives the signature response from the hardware token 210 with the included signature 220. In a step 308, the terminal device 206 forwards the signature 220 to the backend 204, in order that a verification of the signature takes place there. Since the initial data 212 was not included in the signature response from the hardware token 210, the terminal device does not forward this data 213 to the backend 204 either. More precisely, neither the initial data 212 should reach the backend 204 nor should the data structure actually signed by the hardware token 210, which also comprises the data item 222 in addition to the initial data 212.

In a corresponding step 362 (method 360 in FIG. 3C), the request for verification is received by the terminal device 206 in the backend 204. Signature data is provided in a subsequent step 364. The signature data can comprise, for example, the initial data 212 which has reached the terminal device 206 from the backend 204 in step 302. More precisely, the backend 204 should compile this signature data independently of any data contained, for example, in the request received in step 362. According to the invention, the backend 204 must proceed in this way, because, as described, the request for verification does not return the initial data 212.

In a step 366, the backend 204 verifies the signature 220 based on data comprising the signature data compiled in the backend 204 and a predefined further data item; the latter can be the permanently predefined data item 222 described above, which is stored in the hardware token 210 and in the backend 204. The backend 204 can derive the consideration of this data item 222 during the verification from the request received in step 362, if this contains a reference to, e.g., a “Hardware Token Data Attestation”. Alternatively, in the case of a limited number of signature alternatives, the backend 204 could perform a blind detection, in which when a first approach to the verification (without including the data item 222) fails, the verification is repeated including the data item 222. In this way, a method according to the invention could be implemented particularly easily.

In a step 368, the backend 204 sends a response to the request received in step 362, wherein the response relates to a result of the verification, that is, e.g. a positive confirmation of a successful verification, possibly combined with an indication relating to an action carried out by the backend 204 as a result of the positive verification (depending on the individual use case). This completes the verification in the backend 204.

In a step 310, the terminal device 206 receives the response message for verification and, optionally, proceeds accordingly, depending on the use case. This completes the signature creation and verification process in the terminal device 206.

The following exemplary embodiment illustrates a definition of a signature command according to the invention in the manner of a CCC specification. The numbering of the tables and listings is related to a preliminary CCC specification of the Digital Key Release 4 and may be considered arbitrary for the given explanation.

### HARDWARE TOKEN SIGN Command

This command signs a field of arbitrary data using the private key of the selected endpoint. The command can be used with or without user authentication; a different “usage” value is included in the signature to distinguish between these two contexts.
Command: CLA2 30 [Table 15-54] 00 Lc [Table 15-55] 00
Response: [Table 15-57] 90 00

TABLE 15-54
SIGN command Payload

| P1 value | Description | Domain version |
|---|---|---|
| 00ₕ | RFU | V-D-TX |
| 01ₕ | User authentication is not | V-D-TX |
| | required | |
| 02ₕ-FFₕ | RFU | N/A |

CLA2 is defined as in Table 15-3.

TABLE 15-55
SIGN command Payload

| | Length | | | Domain |
|---|---|---|---|---|
| Tag | (bytes) | Description | Field is | version |
| 50ₕ | 20 | Key ID, SHA-1 hash of the value of the BIT | mandatory | V-OD-FW |
| | | STRING subjectPublicKey of the endpoint | | |
| | | certificate issued by the Attestation (without tag, | | |
| | | length, and number of unused bits) | | |
| 58ₕ | 32 | Arbitrary data to be signed | mandatory | N/A. For |
| | | | | information |
| | | | | only |

The hardware token should generate the following data for signing:

TABLE 15-5X
Hardware Token Data Attestation Input

| ASN.1 | Length | | |
|---|---|---|---|
| tag | (bytes) | Description | Field is |
| 04ₕ | variable | ASCII (0x4841524457415245544F4B454E) = | mandatory |
| | | “HARDWARETOKEN” | |
| 04ₕ | variable | Arbitrary data as received in the command | mandatory |
| | | entry | |

TABLE 15-60
SIGN data fields

| | Length | | | |
|---|---|---|---|---|
| Tag | (bytes) | Description | Field is | Domain version |
| 41ₕ | 1 | Version = 01ₕ, version of the signature data fields | mandatory | V-D-TX |
| 92ₕ | 8 | Random | mandatory | N/A. For |
| | | | | information only |
| 5Dₕ | 20 | Key ID, 160-bit SHA-1 hash of the value of the | mandatory | V-OD-FW |
| | | BIT STRING subjectPublicKey of the endpoint | | |
| | | certificate that issued the Attestation (excluding | | |
| | | the tag, length, and number of unused bits) | | |
| 58ₕ | 32 | Arbitrary data as SHA-256 of the input from | mandatory | N/A. For |
| | | Table 15-5X | | information only |
| 93ₕ | 4 | Usage = FC6F4C17ₕ, user authentication was not | mandatory | N/A. For |
| | | performed | | information only |

The following table describes the contents of the SIGN response:

TABLE 15-61
HARDWARE TOKEN SIGN Response

| Tag | Length (bytes) | Description | Field is |
|---|---|---|---|
| 7FXXDₕ | variable | Hardware Token arbitrary data attestation | mandatory |
| Contents of table 15-60 without tag 58h (arbitrary data) | | | mandatory |
| 9Eₕ | 64 | Signature with endpoint. SK over fields in Table | mandatory |
| | | 15-60 | |

Listing 15-35: SIGN processing

| | |
|---|---|
| 1 | Input: P1, key_id, arbitrary_data |
| 2 | Output: signature, random, key_id, version, (counter) |
| 3 | Start |
| 4 | if key_id does not match any of the existing endpoints or the destination endpoint is terminated |
| 5 | return 6A88ₕ |
| 6 | if SIGN is not permitted on this endpoint, per Table 15-13 |
| 7 | return 6900ₕ |
| 12 | if P1 == 01ₕ |
| 13 | Usage FC6F4C17ₕ |
| 14 | or |
| 15 | return 6A86ₕ |
| 16 | Version ← 01ₕ |
| 17 | generate 8 bytes randomly according to listing 15-39, to be added in data_fields in accordance with |
| | Table 15-60 |
| 18 | generate data fields to be signed in accordance with Table 15-60 |
| 19 | version, usage, key_id, random, arbitrary_data |
| 20 | generate signature in accordance with listing 15-42 using data_fields and nvm.endpoint.SK of the |
| | current endpoint |
| 21 | return signature, random, key_id, version |
| 22 | End |

Embodiments of the invention implement a selection or distinction between a signature created with a device-internal key (device integrity) and a signature created with an external key held on a hardware token. Hardware tokens such as corresponding smart cards will likely become more widespread in future. A hardware token implemented according to the invention cannot be used to fake a signature created by an internal key (or vice versa). Proposals according to the invention for robust verification in the backend are also described herein.

Embodiments of the invention support the robustness and trustworthiness of the entire signature and verification procedure for arbitrary (diverse) data, e.g. in a CCC environment. Measures to implement a signature creation on a hardware token are proposed, such as adding a fixed value to the arbitrary data. Such embodiments can be implemented in a simple and highly error-proof manner and make HW tokens more expensive in a cost-sensitive environment (e.g. smart cards in a vehicle environment, fleet management, etc.).

Embodiments according to the invention enforce a robust implementation of a verification or verification process in a backend, e.g. if the arbitrary data is not returned if the signature is not (only) created on that data, etc. The backend can also easily determine independently whether a signature was created internally to the device or by means of an external smart card, etc.

Embodiments of the invention provide technical measures with which reliable and robust methods for creating and verifying signatures for arbitrary (diverse) data can be implemented. Embodiments of the invention are therefore suitable for generally supporting and increasing confidence in the use of digital vehicle keys in an extended vehicle environment. In general, confidence in the practicability and security of digital vehicle keys, associated key management, etc. will be increased, and this is of great importance in view of the increasing prevalence of digital vehicle keys.

Embodiments of the invention are of commercial interest, e.g. for vehicle manufacturers, equipment manufacturers, car-sharing providers, third-party service providers such as roadside assistance, parking service, etc., as well as all suppliers or delivery companies (in particular Tier 1) of digital vehicle keys.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
102 motor vehicle
104 backend server
106 terminal device
108 user
110 hardware token
112 signature key
114 sending arbitrary data to terminal device
116 sending arbitrary data to hardware token
118 process of signature creation in the HW token
120 response with signature created on terminal device
122 forwarding signature data to backend
124 verification in the backend
126 arbitrary data
128 signature module
130 input data for attestation
132 user authentication
134 predefined data item
136 created signature
200 system
202 motor vehicle
204 backend server
206 terminal device
210 hardware token
212 signature data
214 parameter
216 signature key
218 vehicle key
220 signature
222 predefined data item
300 method
302-310 method steps
330 method
332-336 method steps
360 method
362-368 method steps

What is claimed is:

1. A method for controlling a signature creation, the method comprising:
receiving signature data;
sending a signature request to sign the received signature data with a hardware token;
receiving a signature response to the signature request, wherein the signature response comprises a signature; and
forwarding the signature for verification of the signature.

2. The method according to claim 1, wherein the signature request comprises a parameter which is set to a value indicating that a user authentication is not required.

3. A method for signature creation in a hardware token, the method comprising:
receiving a signature request to sign signature data from a terminal device;
creating a signature with a digital signature key, wherein the digital signature key is stored in the hardware token, and wherein the signature is created based on data comprising the signature data and a predefined further data item; and
sending a signature response comprising the signature to the terminal device.

4. The method according to claim 3, wherein the predefined further data item is a fixed value.

5. The method according to claim 4, wherein the predefined further data item comprises a string “HARDWARETOKEN”.

6. The method according to claim 3, wherein the signature response does not contain the signature data.

7. The method according to claim 6, wherein a tag 0x58 is not contained in a CCC context.

8. A method for signature creation in a hardware token, the method comprising:
receiving a signature request to sign signature data from a terminal device;
creating a signature with a digital signature key, wherein the digital signature key is stored in the hardware token; and
sending a signature response comprising the signature to the terminal device, wherein the signature response does not contain the signature data.

9. The method according to claim 8, wherein the signature is created based on data comprising the signature data and a predefined further data item.

10. The method according to claim 3, wherein the method does not provide user authentication.

11. A method for verifying a signature, the method comprising:
receiving a request comprising the signature from a terminal device;
providing signature data;
verifying the signature based on data comprising the signature data and a predefined further data item; and
sending a response to the request, wherein the response relates to a result of the verification.

12. A terminal device configured to perform a method for controlling a signature creation according to claim 1.

13. A hardware token, wherein:
a digital signature key is stored on the hardware token; and
the hardware token is configured to carry out a method for controlling a signature creation according to claim 3.

14. A backend server comprising a processor configured to perform a method for verifying a signature according to claim 11.

15. A system for creating and verifying a signature in the environment of a motor vehicle, comprising:
the motor vehicle;
a hardware token, wherein:
a digital signature key is stored on the hardware token, and
the hardware token is configured to carry out a method for signature creation in a hardware token, comprising:
receiving a signature request to sign signature data from a terminal device;
creating a signature with a digital signature key, wherein the digital signature key is stored in the hardware token, and wherein the signature is created based on data comprising the signature data and a predefined further data item; and
sending a signature response comprising the signature to the terminal device;
a terminal device, wherein an application of a manufacturer of the motor vehicle for signature creation is installed on the terminal device, the terminal device configured to perform a method for controlling a signature creation, comprising:
receiving signature data;
sending a signature request to sign the received signature data with a hardware token;
receiving a signature response to the signature request, wherein the signature response comprises a signature; and
forwarding the signature for verification of the signature;
a backend server, operated by the manufacturer of the motor vehicle, the backend server comprising a processor configured to perform a method for verifying a signature, comprising:
receiving a request comprising the signature from a terminal device;
providing signature data;
verifying the signature based on data comprising the signature data and a predefined further data item; and
sending a response to the request, wherein the response relates to a result of the verification.
